(19) United States
(12) Patent Application Publication
(10) Pub. No.: US 2008/0020155 A1
(43) Pub. Date: Jan. 24, 2008

(54) Lapmate

(76) Inventors: Karen Taatjes, Lompoc, CA (US); Jeff Taatjes, Lompoc, CA (US)

Correspondence Address: JAMES RAY & ASSOCIATES, 2640 PITCAIRN ROAD, MONROEVILLE, PA, 15146, US

(21) Appl. No.: 11/489,206

(22) Filed: Jul. 19, 2006

(51) Int. Cl. B32B 27/10

(52) U.S. Cl. 428/34.2

(57) ABSTRACT

A disposable place mat comprising a base member formed of a predetermined material. There is a foldable border disposed around each side of the base member, such foldable border having a predetermined height when each side is folded up and an extension with a strip of tape disposed thereon at each corner of the foldable border for securing each side of the foldable border to an adjacent side so as to form an enclosure around a periphery of the base member.

### CROSS REFERENCE TO RELATED APPLICATIONS

This application is closely related to and claims benefit from U.S. Provisional Application Ser. No. 60/113,264 filed Aug. 12, 2005.

### FIELD OF THE INVENTION

The present invention relates, in general, to a lap tray, and, more particularly, the present invention relates to a disposable place mat for the lap for preventing foods from spilling on the lap or the car's upholstery.

### BACKGROUND OF THE INVENTION

When taking kids to sports practice, running errands, hurrying to meetings or doing any of the many chores that must be done in today's society, eating on the go is very common. Eating in the car, particularly when the car is moving, is not easy and is often messy. The vehicle and the lap are the casualties of this practice Those who travel with pets are also forced to feed them in the vehicle, which also can create a messy problem.

Eating in restaurants with little children also presents a challenge of a different sort. The high chair trays may be unsanitary. Often after being used they are just quickly wiped down which can leave bacteria on the tray.

Thus, it would be advantageous if there were an apparatus that could be used to protect against spills when eating in the car and also be used to insure that the surface that an infant is eating on is clean and free of germs.

### SUMMARY OF THE INVENTION

In a first embodiment the present invention provides a disposable place mat. The disposable place mat comprises a base member having a predetermined shape and formed of a predetermined material. There is a foldable border disposed around each side of the base member, such foldable border having a predetermined height when each side is folded up and a means disposed at each corner of the foldable border for securing each side of the foldable border to an adjacent side so as to form an enclosure around a periphery of the base member.

### OBJECTS OF THE INVENTION

It is, therefore, one of the primary objects of the present invention to provide a disposable place mat.

Another object of the present invention is to provide a disposable place mat that can be used when eating in a car.

Still another object of the present invention is to provide a disposable place mat that prevent food from spilling, dripping or crumbling on a lap.

Yet another object of the present invention is to provide a disposable place mat that can be used to place a pets food in a car so as to keep the upholstery clean.

These and various other objects and advantages of this invention will become apparent after a full reading of the following detailed description, particularly, when read in conjunction with the attached drawings as described below and the appended claims.

### BRIEF DESCRIPTION OF THE DRAWINGS

FIG. 1 is a perspective view of the apparatus according to an embodiment of the invention showing an unassembled place mat.

FIG. 2 is a perspective view of the apparatus shown in FIG. 1 showing an assembled place mat.

FIG. 3 is a perspective view of the apparatus shown in FIG. 1 as used on a high chair.

FIG. 4A, B and C are perspective views showing a variety of designs possible with the apparatus shown in FIG. 1.

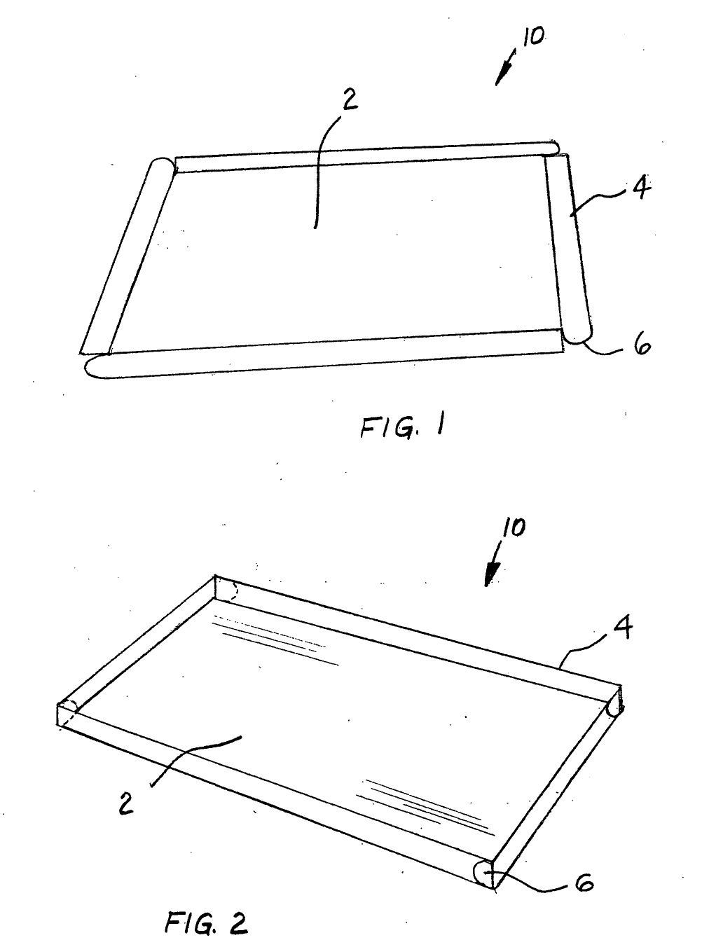

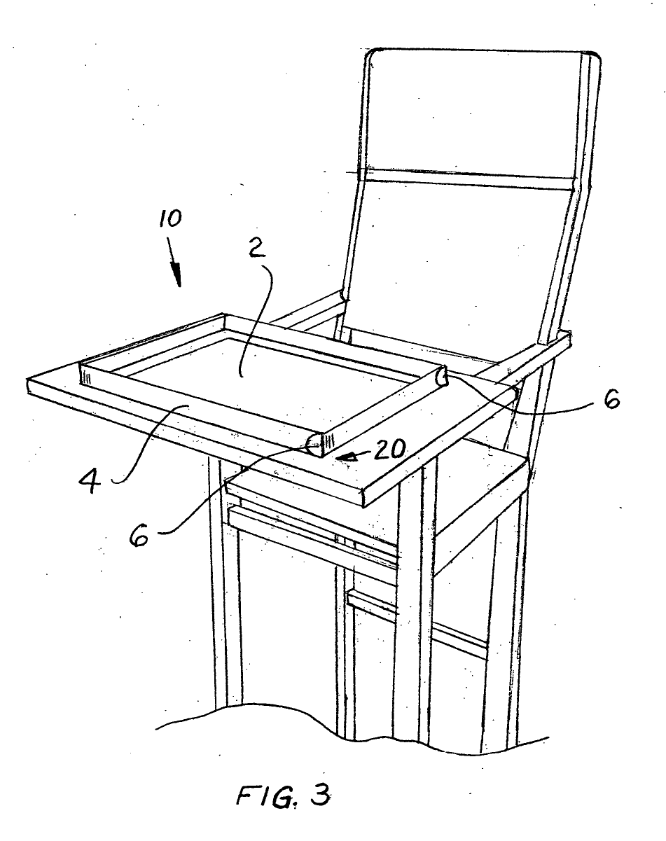

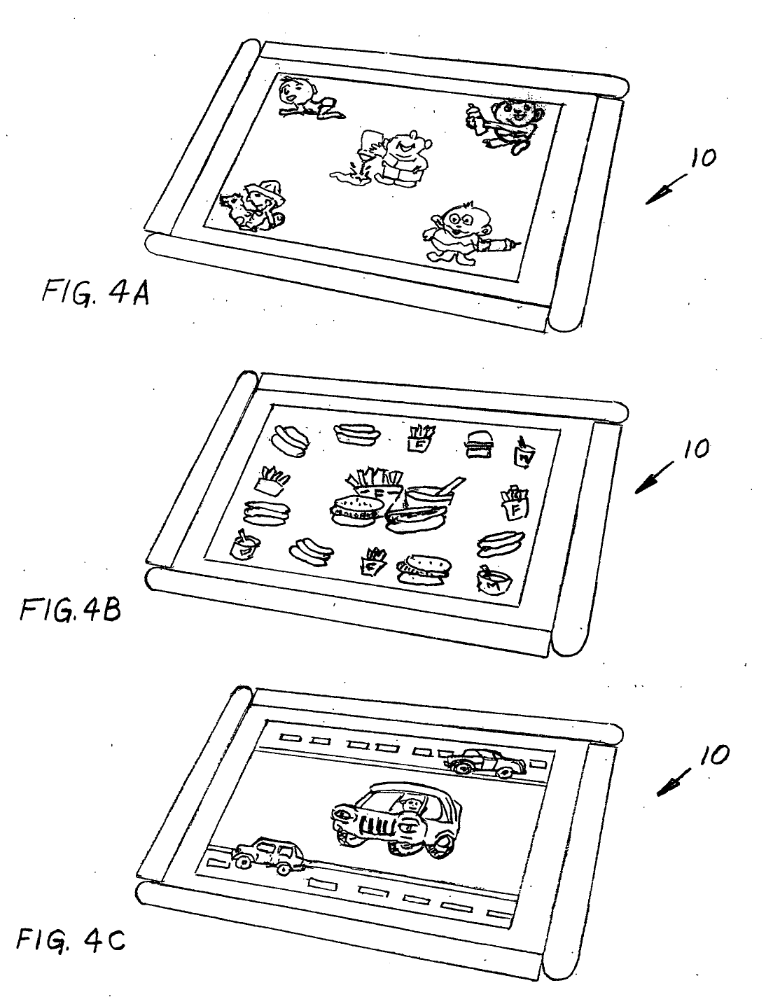

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first embodiment the present invention provides a disposable place mat, generally designated 10. The disposable place mat 10 comprises a base member 2 formed of a predetermined material. There is a foldable border 4 disposed around each side of the base member 2, such foldable border 4 having a predetermined height when each side is folded up and a means, generally designated 20, disposed at each corner of the foldable border 4 for securing each side of the foldable border 4 to an adjacent side so as to form an enclosure around a periphery of the base member 2.

The predetermined shape of the base member 2 includes a shape wherein there is a plurality of substantially straight sides. Such shape could be one of hexagonal, octagonal or rectangular. It is presently preferred that such predetermined shape be rectangular.

Such means 20 for securing corners of foldable border 4 includes an extension 6 disposed on one end of each side adjacent a corner, such extension 6 including a strip of tape for securing each side to an adjacent side of the foldable border 4 to form corners. The strip of tape on the extension 6 has a backing which peels off when the strip of tape is ready for securing the sides to each other so as to form the corners.

The disposable place mat 10 forms a container resembling a cookie sheet when the sides of the foldable border 4 are folded up and secured at the corners.

Such predetermined material used to form such disposable place mat 10 is selected from one of plastic and plastic covered paperboard. It is presently preferred that such material is plastic and, further, it is preferred that such plastic is polystyrene. Such place mat 10 is substantially water proof in that in that water will not permeate through the disposable place mat but will remain in the tray.

It is within the scope of the invention that such disposable place mat 10 come in colors. The colors can be any of a variety of colors so as to make it more appealing to the user, particularly when used by children. Further, it is also within the scope of the invention that such place mat 10 includes designs on the upper surface of place mat 10. Such designs are selected from at least one of geometric designs, peace signs, flowers, animals, trucks, ABC blocks, balls, sports equipment and super heroes. Again these designs are primarily designed to appeal to children.

The disposable place mat 10 is sufficiently rigid so as to sit on a person's lap once the foldable sides 4 are folded up and secured. This makes it usable for a person to eat in the car and have the place mat 10 remain in his/her lap without the fear of having it bend while in use. Such place mat 10 can also be used on a high chair tray. This is important, particularly when eating out in a restaurant where all that is generally done between uses is to quickly wipe the tray of the high chair which may leave the surface in an unsanitary condition. With the place mat 10 on the high chair, the toddler's food will be on a clean surface and thus negate the worry of germs being on the tray and since the place mat 10 is disposable it can just be thrown away after use.

Another use for such place mat 10 is as a place to put a pet's food or water bowls on when traveling in a car with a pet. This keeps the food off of the car's upholstery and in the tray.

While a presently preferred embodiment and alternate embodiments of the present invention has been described in detail above, it should be understood that various other adaptations and/or modifications of the invention can be made by those persons who are particularly skilled in the art without departing from either the spirit of the invention or the scope of the appended claims.

We claim:

1. A disposable place mat, said disposable place mat comprising:
(a) a member having a predetermined shape and formed of a predetermined material;
(b) a foldable border disposed around each side of said substantially rectangular member, said foldable border having a predetermined height when said each side is folded up; and
(c) a means disposed at each corner of said foldable border for securing said each side of said foldable border to an adjacent side so as to form an enclosure around a periphery of said base member.

2. The disposable place mat, according to claim 1, wherein said predetermined shape of said base member includes a predetermined plurality of substantially straight sides.

3. The disposable place mat, according to claim 2, wherein said predetermined shape of said base member is one of hexagonal, octagonal and rectangular.

4. The disposable place mat, according to claim 3, wherein said predetermined shape of said base member is rectangular.

5. The disposable place mat, according to claim 1, wherein said means for securing corners of said foldable border includes an extension disposed on one end of each side adjacent each corner, said extension including a strip of tape for securing each side to an adjacent side of said foldable border to form corners.

6. The disposable place mat, according to claim 5, wherein said strip of tape has a backing which peels when said strip of tape is ready for securing said sides to form said corners.

7. The disposable place mat, according to claim 4, wherein said substantially rectangular member with said sides folded up and secured at said corners forms a container resembling a cookie sheet.

8. The disposable place mat, according to claim 1, wherein said predetermined material is selected from one of plastic and plastic covered paperboard.

9. The disposable place mat, according to claim 8, wherein said predetermined material is plastic.

10. The disposable place mat, according to claim 9, wherein said plastic is polystyrene.

11. The disposable place mat, according to claim 10, wherein said disposable place mat is substantially water proof in that water will not permeate through said disposable place mat.

12. The disposable place mat, according to claim 1, wherein said disposable place mat is made in a variety of colors.

13. The disposable place mat, according to claim 1, wherein said upper surface of said disposable place mat further includes designs selected from at least one of geometric designs, peace signs, flowers, animals, trucks, ABC blocks, balls, sports equipment and super heroes.

14. The disposable place mat, according to claim 1, wherein said disposable place mat is sufficiently rigid so as to sit on a person's lap once said sides are folded up and secured.

15. The disposable place mat, according to claim 1, wherein said disposable place mat can be used on a high chair tray.

16. The disposable place mat, according to claim 1, wherein said disposable place mat can be used as a tray for eating in a automobile.

17. The disposable place mat, according to claim 1, wherein said disposable place mat can be used as a tray upon which a pet's food and water bowls can be place when traveling with pets in a automobile.
